(19) United States
(12) Patent Application Publication
(10) Pub. No.: US 2012/0158614 A1
(43) Pub. Date: Jun. 21, 2012

(54) Executing a Leveraged Long/Short Strategy for an ETF

(76) Inventors: Suleiman Samandar, (US); Jason LaMacchia, (US); Andrew S. Josef, (US)

(21) Appl. No.: 13/164,555

(22) Filed: Jun. 20, 2011

Related U.S. Application Data
(60) Provisional application No. 61/356,629, filed on Jun. 20, 2010.

(51) Int. Cl. G06Q 40/04; G06Q 40/06

(52) U.S. Cl. 705/36 R

(57) ABSTRACT

An ETF uses a leveraged long/short strategy that involves buying fully funded equities that are expected to overperform in the market, selling short equities that are expected to underperform, and buying additional equities that are expected to overperform using proceeds generated from the short sales. This is achieved for an ETF by creating and redeeming ETF shares, wherein the ETF fund manager specifies in a portfolio composition file which equities to buy and which equities to sell short. To create shares of the ETF, an authorized participant transfers these specified positions to the fund manager “in kind” in exchange for ETF shares. To redeem shares of the ETF, the authorized participant transfers the shares back to the fund manager and in return receives these specified positions in-kind from the fund manager. This avoids the need for the ETF fund manager to initiate the short sale.

### CROSS REFERENCE TO RELATED APPLICATIONS

This application claims the benefit of U.S. Provisional Application No. 61/356,629, filed Jun. 20, 2010, which is incorporated by reference in its entirety.

### BACKGROUND

This invention relates generally to financial services and products, and more particularly to financial systems that enable a leveraged long/short management strategy for an exchange traded fund (ETF).

In a long strategy, an investor buys an equity that the investor expects will perform well in the market (i.e., overperform the market's pricing equities generally). The investor makes money when the price of that equity rises. Conversely, in a short strategy, an investor borrows shares of an equity that the investor expects will underperform in the market and then sells those shares. The investor thus has a short position with respect to that equity, since the investor will need to buy back those shares later in order to repay the loan. The investor makes money in the short strategy when the price of the equity drops, since the investor can repay the loan by purchasing the shares at a lower price than that for which the investor originally sold the shares.

Investing strategies often employ a combination of long and short strategies for different securities. One way to increase the expected returns with a long/short strategy is to use the cash proceeds from the short sale, the loaned long securities, or other cash to purchase additional long positions in equities. These long positions may be called “levered longs,” since the investor has leveraged the portfolio to gain exposure to additional equities. For a number of reasons, it is difficult to implement an effective levered long/short strategy in the management of an ETF. For example, short sales require collateral, and since the creation process for an ETF settles on a T+3 timeline, the ETF fund manager cannot collateralize the loan (e.g., by lending the long position) until the equities have been transferred (at T+3).

### SUMMARY

Embodiments of the invention enable executing a long/short strategy for an ETF that leverages the short positions to generate additional exposure to equities, referred to as levered longs. In a long/short strategy, in accordance with one embodiment of the invention, the fund's strategy involves (1) buying fully funded equities that are expected to overperform, (2) selling short equities that are expected to underperform, and (3) buying additional equities that are expected to overperform using proceeds generated from the short sales. This is achieved for an ETF by creating and redeeming ETF shares, wherein the ETF fund manager specifies (e.g., in a portfolio composition file, or PCF) which equities to buy and which equities to sell short. To create shares of the ETF, an authorized participant transfers these specified positions to the fund manager “in kind” in exchange for ETF shares. To redeem shares of the ETF, the authorized participant transfers the shares back to the fund manager and in return receives these specified positions in-kind from the fund manager. By using the in-kind transfer of the long (including the levered longs) and the short positions, the ETF fund manager need not initiate the short sale because the authorized participant is instructed to do so (in the PCF).

### BRIEF DESCRIPTION OF THE DRAWINGS

FIG. 1 illustrates a simplified creation process for an ETF, in accordance with an embodiment of the invention.

FIG. 2 is a diagram of a creation process for shares of an ETF that uses a leveraged long/short strategy, in accordance with one embodiment of the invention.

FIG. 3 is a diagram of a redemption process for shares of an ETF that uses a leveraged long/short strategy, in accordance with one embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview of ETF Creation, Redemption, and Trading on a Secondary Market

Investors commonly invest in different types of funds to gain exposure to various types of securities, including bonds and other fixed-income securities. A very popular type of fund is an exchange-traded fund, or ETF. Shares of an ETF are securities that represent a legal right of ownership over an underlying portfolio of securities or other assets held by the issuing fund. The assets held by an ETF may include individual stocks, bonds, cash, commodities, derivatives, or any tradable asset, including contracts based on the value of any of the foregoing. Shares of an ETF are designed to be listed on a securities exchange and traded over the exchange just like other securities. ETFs thus allow an investor to own a set or “basket” of assets by simply purchasing shares in the individual ETF. Many existing ETFs hold a mix of assets that aim to replicate or otherwise match the characteristics of a particular published index. These ETFs allow investors to have exposure to the index by purchasing shares of the single ETF. Because of their low cost and tax advantages, ETFs have grown in popularity in recent years.

A typical ETF resembles an index mutual fund in that an ETF generally holds a basket of securities designed to replicate the returns of a securities index, has lower fees than comparable actively-managed mutual funds, and is required to permit daily redemptions at the current value of its holdings (also known as “Net Asset Value”). But unlike mutual funds, ETF shares trade on an exchange throughout the trading day, and most investors must buy and sell shares on the exchange rather than directly purchase and redeem from the fund itself (as is the case with mutual funds). Unlike mutual funds, most transactions in ETF shares are conducted in the secondary market (i.e., on an exchange) and do not involve the movement of assets in or out of the fund. In the case of transactions in creation units that do involve the movement of assets into or out of the fund, the transactions are routinely effected by giving the redeeming shareholder its pro rata share of the fund's holdings, which does not impose trading costs or adverse tax consequences on the remaining shareholders.

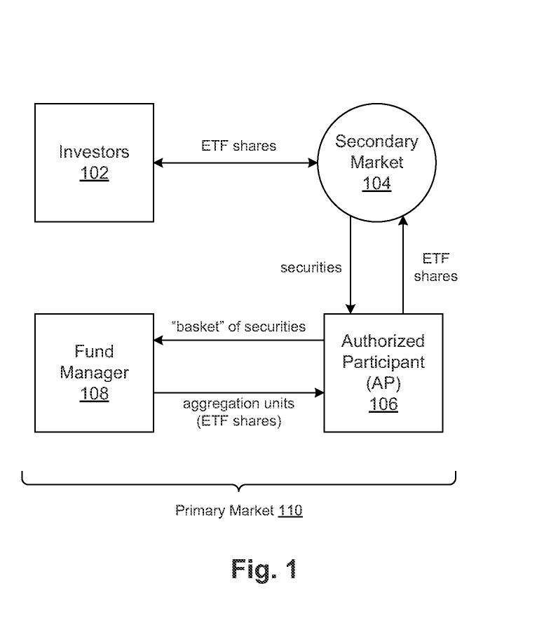

The shares of an ETF are generally made available to investors 102 through a two-tiered market structure, which includes a primary market 110 and a secondary market 104. FIG. 1 illustrates a simplified creation process for an ETF (or “fund”), in the primary market 110 in accordance with one embodiment. In the primary market 110, issuance of new shares of the ETF can be created only in multiples of a minimum block of shares (“creation units”). Because of the large size of the minimum creation units required for purchases of new ETF shares, these shares are generally only available in the primary market 110 to certain institutional investors known as authorized participants 106. Authorized participants 106 are typically large institutional broker dealers or market makers that transact directly with an ETF for purchases of creation units of the ETF shares at the end of day net asset value (“NAV”) for the ETF.

As shown, the consideration for purchase of a creation unit of an ETF generally consists of a deposit of a basket of securities via an in-kind exchange of those securities and a deposit of cash to make up any difference between the value of the deposit securities delivered into the ETF and the value of the shares of the ETF (or NAV) issued by a fund manager 108 to the authorized participant 106. In certain limited circumstances, cash may also be delivered in lieu of all or a portion of the specified basket of securities if the securities are not available in sufficient quantity or otherwise cannot be delivered or in certain other situations. The deposit securities are obtained and delivered by the authorized participant 106 to the fund, which are then added to the fund's holdings. The particular mix of securities to be deposited by the authorized participant 106 in exchange for the creation units are specified by a “basket,” which is published by the fund manager 108 each business day in a portfolio composition file (PCF).

The opposite process occurs for a redemption of the ETF. In one embodiment, an authorized participant 106 can redeem shares of an ETF by delivering a block of the ETF shares (e.g., the same size block as in a creation unit) to the fund. In exchange, the fund delivers via an in-kind transfer the deposit securities specified in the published basket (e.g., in the PCF) associated with the ETF. In both the creation and redemption processes, a cash component is delivered in either direction to offset any differences between the actual value of the deposit securities and that of the ETF shares exchanged. As stated earlier, in certain limited circumstances, cash may also be delivered in lieu of all or a portion of the specified basket of securities if the securities are not available in sufficient quantity or otherwise cannot be delivered or in certain other situations.

In contrast to the primary market 110, in which authorized participants 106 may transact for the creation or redemption of creation size units of an ETF, individual investors 102 can access ETF shares in the secondary market 104. Once the block of ETF shares in the creation size units is received by the authorized participant 106, the shares may be broken down into less than creation unit sizes (including individual shares) and sold by the authorized participant 106 directly to customers or over a secondary market 104, where individual investors 102 may buy and sell shares of the ETF through their brokerage accounts. An intermediary, such as a broker/dealer or financial advisor, may advise investors 102 directly and recommend and sell the ETF shares.

The process flow and systems for trading ETFs are described in more detail in U.S. Pat. No. 7,937,316, issued May 3, 2011, and in U.S. application Ser. No. 12/651,976, filed Jan. 4, 2010, each of which is incorporated by reference in its entirety.

### Leveraged Long/Short Strategy for an ETF

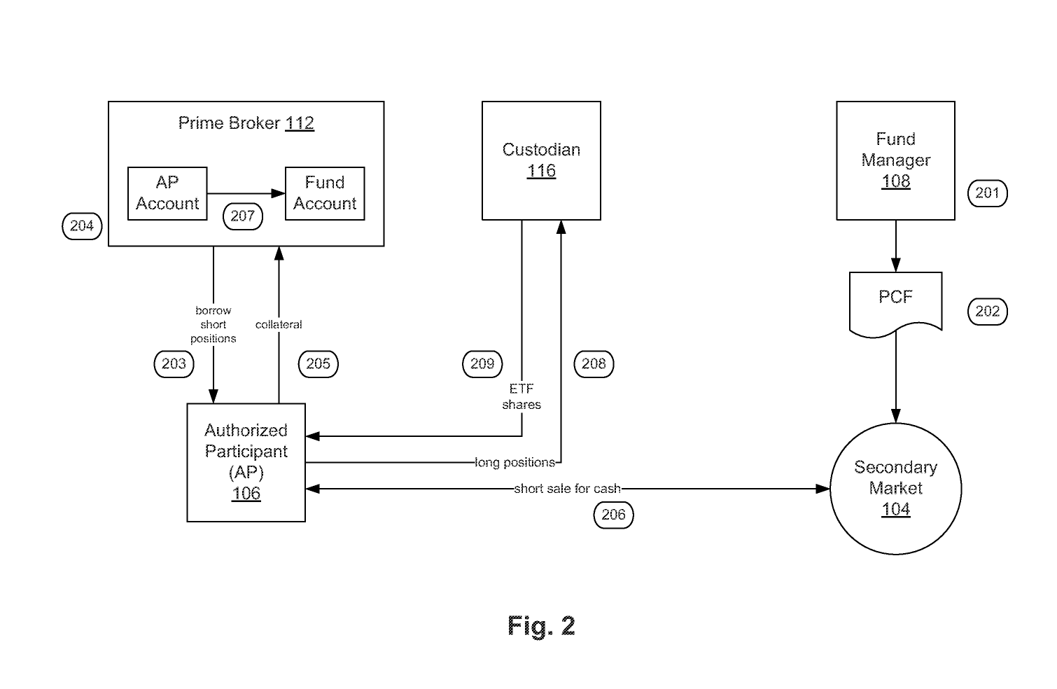

FIG. 2 illustrates embodiments of a process for creating shares of an ETF that uses a leveraged long/short strategy. In this process, in step 201, the fund manager 108 runs an optimization algorithm to generate a set of desired long and short holdings for the fund. The long holdings represent long positions in one or more securities that are expected to overperform in the market, and the short holdings represent short positions in one or more securities that are expected to underperform in the market. The long holdings include the levered long positions resulting from purchases made using the proceeds from the short sales associated with the short positions. This optimization may be performed manually, by an automated process, or by some combination of both. The optimization is repeated, such as in daily intervals, so that the selection of the desired long and short holdings for the fund can track market conditions.

In step 202, the fund manager 108 generates and publishes a portfolio composition file (PCF), which specifies the set of desired long and short holdings for the fund. PCFs are commonly used by fund manager 108 to specify the assets required to create or redeem shares of the ETF. In an embodiment, the PCF is published through a well-recognized service or directly by the fund manager 108. An authorized participant 106 (AP) that desires to create new shares of the ETF can then review the published PCF to determine the long and short positions that are required to create new shares of the fund.

Based on the short positions specified in the PCF, the authorized participant 106 contacts a prime broker 112 in step 203 to borrow the securities associated with the short position in the PCF. The prime broker 112 then responds to the authorized participant 106 with the availability of the requested securities, and if the requested securities are available, the prime broker 112 transfers those securities to the authorized participant 106. Once the authorized participant 106 has borrowed these securities from the prime broker 112, the prime broker 112 creates an obligation or liability in the authorized participant 106's account with the prime broker 112, in step 204. This obligation requires collateralization of the loan as well as an eventual return of the borrowed securities. Accordingly, the authorized participant 106 collateralizes the short position in the authorized participant 106's account at the prime broker 112, in step 205, e.g., by transferring sufficient cash as collateral for the loan. To complete the short sale, in step 206, the authorized participant 106 then typically sells the borrowed securities in a secondary market 104.

Upon placing a creation order with the fund manager 108, the authorized participant 106 instructs the prime broker 112 to move the obligation for the borrowed securities and the cash collateral covering the borrowed securities from the authorized participant 106's account to the fund's account, in step 207. In this way, the fund has the liability for the short position as well as the collateral to cover the obligation. The authorized participant 106 also delivers all of the long positions specified in the PCF to the fund manager 108 free-of-payment (FOP), in step 208. This delivery may be made to a custodian 116 specified by the fund manager 108.

In response to delivery of the long and short positions form the authorized participant 106 to the fund manager 108, the transfer agent or fund then issues shares of the ETF, which are transferred to the authorized participant 106 in step 209. The value of the shares issued to the authorized participant 106 corresponds to the value of the long and short positions transferred to the fund manager 108. If necessary, the custodian 116 returns any cash balance back to the authorized participant 106 only after receiving full value from the authorized participant 106, where full value includes both all long holdings and short holdings specified in the PCF. Once the shares of the ETF have been transferred to the authorized participant 106, the authorized participant 106 may sells the shares on the secondary market 104.

In one embodiment, on the settlement date of the ETF (e.g., at T+3), the fund manager 108 collateralizes the short position using cash from the proceeds from lending fully paid securities. Alternatively, on the settlement cycle of the ETF, the fund manager 108 collateralizes the short position by raising cash borrowed from the prime broker 112 or by pledging fully paid securities.

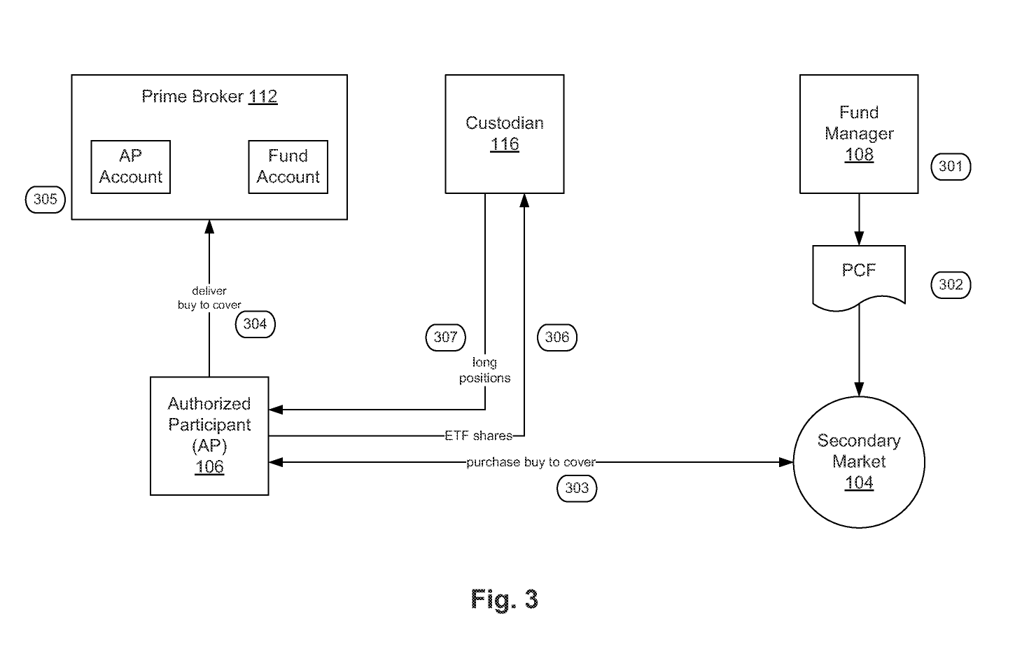

FIG. 3 illustrates embodiments of a process for redeeming shares of an ETF that uses a leveraged long/short strategy, such as shares of the ETF created according to the process illustrated in FIG. 2. In this process, as in FIG. 2, the fund manager 108 runs an optimization algorithm to generate a set of desired long and short holdings for the fund, in step 301. This optimization may be performed manually, by an automated process, or by some combination of both. The optimization is repeated, such as in daily intervals, so that the selection of the desired long and short holdings for the fund can track market conditions or the index. In step 302, the fund manager 108 generates and publishes a portfolio composition file (PCF), which specifies the set of desired long and short holdings for the fund.

Based on the short positions specified in the PCF, an authorized participant 106 purchases sufficient securities in a secondary market 104 to cover those short positions (buy-to-cover), in step 303. In step 304, the authorized participant 106 then delivers these buy-to-cover securities to the prime broker 112 in connection with the fund manager 108's account. The delivery of these securities closes the short positions at the fund manager 108's account at the prime broker 112, so the prime broker 112 closes the fund manager 108's obligation, in step 305. In step 306, the authorized participant 106 delivers shares of the ETF, which the authorized participant 106 may have obtained in the secondary market 104, to the custodian 116. After receiving full value (including the ETF shares and the buy-to-cover securities associated with the short position specified in the PCF), the custodian 116 delivers to the authorized participant 106 the securities associated with the long positions specified in the PCF (including the levered long positions) free-of-payment (FOP) and any required cash, in step 307.

In the embodiments of the creation process and redemption process discussed above and illustrated in FIGS. 2 and 3, the fund uses a self-financing platform in which the fund manager 108 and the authorized participant 106 establish accounts at the same prime broker 112 for the in-kind transfers of the short positions and use the same custodian 116. This is achieved, for example, by the fund manager 108 specifying to the authorized participant 106 which prime broker 112 and custodian 116 to use for the creation or redemption process. When using this platform, the fund manager 108 lends its fully paid long securities in exchange for the collateral used for the short positions, and the fund manager 108 pledges cash to cover the borrowed securities.

In various embodiments, the fund manager 108 and the authorized participant 106 may establish accounts at the same or at different prime brokers. Establishing accounts at the same prime broker, in some embodiments, may be less expensive and easier to implement ETFs as described herein. In some of these embodiments, the fund manager 108 may collateralize the short position by either borrowing cash from the prime broker 112 or by pledging the fund's fully paid long securities as collateral.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method for creating shares of an exchange traded fund, the method comprising:
publishing an electronic portfolio composition file on a non-transitory computer readable medium by a computing system of a fund manager that administers the exchange traded fund (ETF), the portfolio composition file specifying a creation basket of assets that includes a long position from purchasing a set of equities, a short position from a short sale of a set of equities, and an additional long position from purchasing set of equities using proceeds from the short sale;
electronically receiving a creation request from an authorized participant at the computing system of the fund manager;
receiving from the authorized participant an in-kind transfer of the assets in the creation basket specified in the published portfolio composition file; and
initiating an ETF creation transaction on a primary market by the computing system of the fund manager, the ETF creation transaction providing shares of the ETF from the fund manager to the authorized participant in exchange for the in-kind transfer of the assets in the creation basket specified in the published portfolio composition file.

2. The method of claim 1, further comprising:
specifying from the fund manager to the authorized participant a prime broker from which to borrow the set of equities for the short sale.

3. The method of claim 1, further comprising:
specifying from the fund manager to the authorized participant a custodian for transferring securities associated with the long positions and shares of the ETF.

3. The method of claim 1, further comprising:
on a settlement date of the ETF creation transaction, lending fully paid securities and collateralizing the short position using cash from proceeds from lending the fully paid securities.

4. The method of claim 1, further comprising:
on a settlement date of the ETF creation transaction, collateralizing the short position using cash borrowed from the prime broker.

5. The method of claim 1, further comprising:
on a settlement date of the ETF creation transaction, collateralizing the short position by pledging fully paid securities.

6. A method for redeeming shares of an exchange traded fund, the method comprising:
publishing an electronic portfolio composition file on a non-transitory computer readable medium by a computing system of a fund manager that administers the exchange traded fund (ETF), the portfolio composition file specifying a redemption basket of assets that includes a long position from purchasing a set of equities, a short position from a short sale of a set of equities, and an additional long position from purchasing set of equities using proceeds from the short sale;
electronically receiving a redemption request from an authorized participant at the computing system of the fund manager;
receiving from the authorized participant shares of the ETF; and
initiating an ETF redemption transaction on the primary market by the computing system of the fund manager, the ETF redemption transaction providing an in-kind transfer of the assets in the creation basket specified in the published portfolio composition file to the authorized participant in exchange for shares of the ETF.

7. The method of claim 6, further comprising:
specifying from the fund manager to the authorized participant a prime broker to deliver the set of equities for covering the short sale.

8. The method of claim 6, further comprising:
specifying from the fund manager to the authorized participant a custodian for transferring securities associated with the long positions and shares of the ETF.

9. A method for creating shares of an exchange traded fund, the method comprising:
publishing an electronic portfolio composition file on a non-transitory computer readable medium by a computing system of a fund manager that administers the exchange traded fund (ETF), the portfolio composition file specifying a creation basket of assets that includes a leveraged long position in a set of equities and a short position from a short sale of a set of equities;
electronically receiving a creation request from an authorized participant at the computing system of the fund manager;
receiving from the authorized participant assets in the creation basket specified in the published portfolio composition file, the received assets including an in-kind transfer of the short position in a set of equities; and
providing shares of the ETF from the fund manager to the authorized participant in exchange for the assets received from the authorized participant.

10. The method of claim 9, further comprising:
specifying from the fund manager to the authorized participant a prime broker from which to borrow the set of equities for the short sale.

11. The method of claim 9, further comprising:
specifying from the fund manager to the authorized participant a custodian for transferring securities associated with the long positions and shares of the ETF.

12. The method of claim 9, further comprising:
on a settlement date of the ETF creation transaction, lending fully paid securities and collateralizing the short position using cash from proceeds from lending the fully paid securities.

13. The method of claim 9, further comprising:
on a settlement date of the ETF creation transaction, collateralizing the short position using cash borrowed from the prime broker.

14. The method of claim 9, further comprising:
on a settlement date of the ETF creation transaction, collateralizing the short position by pledging fully paid securities.

15. A method for redeeming shares of an exchange traded fund, the method comprising:
publishing an electronic portfolio composition file on a non-transitory computer readable medium by a computing system of a fund manager that administers the exchange traded fund (ETF), the portfolio composition file specifying a creation basket of assets that includes a leveraged long position in a set of equities and a short position from a short sale of a set of equities;
electronically receiving a redemption request from an authorized participant at the computing system of the fund manager;
receiving from the authorized participant shares of the ETF; and
providing from the fund manager to the authorized participant assets in the creation basket specified in the published portfolio composition file, the provided assets including an in-kind transfer of the short position in a set of equities, in exchange for the shares of the ETF received from the authorized participant.

16. The method of claim 15, further comprising:
specifying from the fund manager to the authorized participant a prime broker to deliver the set of equities for covering the short sale.

17. The method of claim 15, further comprising:
specifying from the fund manager to the authorized participant a custodian for transferring securities associated with the long positions and shares of the ETF.
